(19) United States
(12) Patent Application Publication
(10) Pub. No.: US 2024/0181688 A1
(43) Pub. Date: Jun. 6, 2024

(54) INJECTION MOLDING DEVICE

(71) Applicant: FOBOHA (Germany) GmbH, Haslach (DE)

(72) Inventors: Rainer Armbruster, Wolfach (DE); Vito Galati, Rowley, MA (US); Salvatore Lograsso, Beverly, MA (US)

(21) Appl. No.: 18/553,305

(22) PCT Filed: Mar. 3, 2022
(86) PCT No.: PCT/EP2022/055381

§ 371 Date: Sep. 29, 2023

Related U.S. Application Data
(60) Provisional application No. 63/168,779, filed on Mar. 31, 2021.

(51) Int. Cl. B29C 45/06; B29C 45/28; B29C 45/73

(52) U.S. Cl. CPC B29C 45/06; B29C 45/2806; B29C 45/7312

(57) ABSTRACT

The disclosure relates to an injection molding device suitable for injection molding and curing of plastic parts. The injection molding device comprises a first mold carrier and a second mold carrier arranged linearly movable relative to each other in a first direction between a proximal position and a distal position. The injection molding device further comprises at least two cavity modules cycling during operation between a first position and at least one second position. The first position being essentially between the first and the second mold carrier and the at least one second position is usually lateral to the first and the second mold carrier.

### FIELD OF THE DISCLOSURE

The present disclosure relates to injection molding devices suitable for injection molding and curing of plastic parts requiring long cooling times.

### BACKGROUND OF THE DISCLOSURE

WO0204186A1 first published in January of 2002 in the name of Foboha relates to a device for the injection moulding of materials. Said device comprises an injection moulding machine and at least one mold which can be actively connected thereto. The injection moulding machine comprises a standardized interface element which can be actively connected to a corresponding interface element pertaining to more than one mold. Means such as substances, energy, and information are exchanged with the at least one mold via the interface part.

WO2006039775A1 first published in April 2006 in the name of Husky Injection Molding is directed to a method of loading a moldset having a core plate and a cavity plate into an injection molding machine. The method comprises the steps of latching a cavity plate to a core plate using a removable latch, guiding the core plate into an open mold along a face in the mold while maintaining separation between the face and the core plate and maintaining the cavity plate spaced from hot runner nozzles in a hot runner in the mold, closing the mold to engage the cavity plate with the hot runner nozzles, securing the cavity plate to the hot runner, removing the latch between the cavity plate and the core plate, and opening the mold.

WO2006077127A1 first published in July of 2006 in the name of Zahoransky GmbH Formen-und Werkzeugbau, relates to an injection molding machine for injection molding of injection molded parts. The machine includes an injection station with an injection molding tool that can be placed inside a holding device. The injection molding tool has a pair of molding inserts, including a nozzle-side mold half and a closing-side mold half. A number of pairs of molding inserts are provided that have locking devices for holding the pairs of molding inserts together when the holding device is open. Thus, they can be removed from the holding device while locked. A conveying device for conveying pairs of molding inserts between the stations is provided.

WO2007096309A1 first published in August of 2007 in the name of Foboha Formenbau GmbH is directed, to an injection molding device for the making of a product comprising at least two material or color components. A device according to the document in general comprises a first stationary mold half and a second movable mold half. A holding frame is arranged between the first and the second mold half. The holding frame may comprise an in mold transfer system or a movable third mold half.

### SUMMARY OF THE DISCLOSURE

The disclosure is generally directed to devices for injection molding of plastic parts, and in particular for injection molding of parts requiring a comparatively long time to cure after the melted plastic has been injected into a cavity. Long cooling time can be necessary due to manufacturing bulky or thick walled plastic parts or due to the material properties of the plastics used, e.g. in case of bioplastics like PLA (polylactide). One aim is to provide an injection molding device suitable to allow for the necessary extended curing time, while keeping the cycle time as short as possible.

An injection molding device according to the disclosure usually comprises a first mold carrier and a second mold carrier arranged linearly movable relative to each other in a first direction between a proximal position and a distal position. The injection molding device further comprises at least two cavity modules cycling during operation between a first position and at least one second position. The first position being essentially between the first and the second mold carrier and the at least one second position usually being lateral to the first and the second mold carrier.

Each of the at least two cavity modules comprises a first mold half and a thereto corresponding second mold half, in a closed state forming at least one cavity therebetween. The at least one cavity being suitable to receive melted plastic material via at least one cavity gate arranged in the first mold half to form at least one plastic part from the melted plastic material by curing.

Usually, the cavity module comprises latching means to lock the first mold half with respect to the second mold half in the closed state during transfer of the cavity module from the first position, between the first and the second mold carrier, into the second position, lateral to the first and the second mold carrier. The latching means can be formed e.g. as bayonet type latching means, comprising a rotatable latching rod engagable with a corresponding socket. However other implementations are possible as well, such as a latching rod having a groove and a clamping element engaging in the groove for locking the latching means. If appropriate the latching means can comprise at least one spring mechanically interconnecting the first mold half and the second mold half.

The injection molding device comprises a melted plastic pass through means usually attached to the first mold carrier and being in the first position of the cavity module, during each molding cycle in the proximal position of the first and the second mold carrier, interconnected to the first mold half of one of the at least two cavity modules for supplying melted plastic material into the cavity via the cavity gate. Typically, the first mold carrier having attached thereto the melted plastic pass through means is stationary during operation. In this case the second mold carrier is arranged linearly movable with respect to the first mold carrier in the first direction. The melted plastic pass through means preferably comprise a hot runner system comprising at least one inlet, a hot runner manifold and typically a plurality of nozzles. The hot runner system may comprise at least one temperature sensor and at least one heating element to maintain during operation an essentially uniform temperature of the melted plastic material passing through, into the at least one cavity.

An injection molding device as described above preferably allows to inject melted plastic material into the at least one cavity of a cavity module, when a cavity module is in the closed state in the first position and the mold carriers are in the proximal position. Once the mold carriers are moved into the distal position the cavity module can be moved in the closed state into the at least one second position, such that the plastic material can cure while another cavity module is cycling from a second position into the first position. This way the time between injections of melted plastic material is minimized, while the material is given the required time to cool and cure.

To summarize, an injection molding device according to the disclosure provides a fast injection cycle time, while allowing a long cooling time for curing of the parts in the at least one cavity.

Further advantages are, that a number differently shaped parts can be manufactured with the same injection molding device, as each cavity of the cavity modules can be differently shaped. In case a cavity module comprises in the closed state more than one cavity, these cavities are typically identical per cavity module, that usually the number of differently shaped parts that can be manufactured in alternating cycles of the same injection molding device corresponds to the number of cavity modules cycling between the first position and a respective second position. However, it is also possible for one of the at least two cavity modules to comprise in the closed state different cavities.

At least one cavity modules may comprise an electronic storage device having stored thereon identification information relating to the cavity module. Preferably the storage device has in addition stored thereon process information. The process information stored in the storage device is usually pre-configured e.g. the process information is derived from computer simulation, such that the set up process of the injection molding device is simplified, as the need for manual input of process parameters is reduced.

In some variations, a controller is configured to control the supply of melted plastic material into the at least one cavity depending on the specific cavity module being in the first position. The cavity module may comprise a communication device interconnected to the storage device, the communication device being configured to transmit information stored in the storage device via a communication network, in particular a wireless communication network, to the controller.

The controller is preferably configured to receive information from the storage device of a cavity module via communication network, in particular via a wireless communication network. The controller can be further configured to control the supply of melted plastic material depending on the identification information and/or the process information received from the cavity module in the first position or the cavity module cycling into the first position. Depending on the field of application, the communication network comprises a mobile radio network, such as GSM (Global System for Mobile Communication), UMTS (Universal Mobile Telephone System), WLAN (Wireless Local Area Network) or the like. However, a close range wireless communication network is also thinkable comprising RFID communication interfaces (Radio Frequency Identifier) or so called NFC (Near Field Communication), optical interfaces like infrared or visual communication interfaces, or Bluetooth.

Depending on the field of application, the melted plastic pass through means comprises per cavity at least one injection nozzle being in the proximal position fluidly interconnected to the respective cavity via the at least one cavity gate for injecting melted plastic material into the respective cavity. Typically, in case voluminous parts, such as car door panels, are manufactured with a single cavity per cavity module, more than one injection nozzle are fluidly interconnected to the cavity via a cavity gate per injection nozzle. Preferably the injection nozzles are configurable and/or controllable to inject melted plastic material sequentially into the cavity to control the melted plastic material's flow front, allowing the movement of weld lines to desired areas within the molded part.

Good results are possible, when the at least one injection nozzle comprises a needle arranged movable between a retracted position and an extended position, to open a nozzle gate in the retracted position and to close the nozzle gate in the extended position. To allow the manufacturing of high quality parts, the needle comprises an end face in the extended position temporarily forming part of the respective cavity. A less recognizable injection mark originating from the cavity gate through which the melted material is injected into the cavity can be achieved this way. The end face should for this purpose form during operation a level, or slightly indented, finish with the cavity. Preferably an insertion depth of the end face in the extended position into the at least one cavity gate is adjustable and/or configurable.

To prevent damage from the end face, the needle is preferably arranged movable to an intermediate position between the retracted and the extended position, such that in the intermediate position the end face closes the nozzle gate arranged in a front face of the melted plastic pass through means in a sealing manner. This allows disconnecting the first mold half and the melted plastic pass through means without damaging the needle.

In order to reduce wear, a lead in is preferably arranged at the nozzle gate for leading the needle when moved into the extended position, in particular for centering the needle coaxially to the cavity gate. If appropriate, the first mold half is in the proximal position aligned with the melted plastic pass through means in a direction perpendicular to the first direction by alignment means. Preferably the alignment means comprise an outer conical surface and an inner conical surface cooperating with each other when the first mold half is interconnected to the melted plastic pass through means.

Good results can be achieved, when the first mold half is in the first position temporarily interconnected to the first mold carrier by first holding means. This allow to separate the first mold half and the second mold half from the closed state into an open state. In the open state the first mold half is spaced apart from the second mold half, such that the plastic parts can be removed/ejected. To support the removal, ejector means can be arranged mechanically interconnected to the cavity to push against the parts to be removed. The ejector means can be formed e.g. by at least one linearly movable ejector pin, however other ejector means are thinkable, such as ejection by means of compressed air.

Generally, the holding means can be driven mechanically and/or pneumatically and/or magnetically and/or hydraulically. If appropriate the second mold half is in the first position temporarily interconnected to the second mold carrier by second holding means. However, in some variations the second mold half is during operation attached to the second mold carrier in a fixed manner.

In a preferred variation the first mold half is arranged linearly displaceable with respect to the second mold half between the open state and the closed state by linear guiding means incorporated in the corresponding cavity module. The linear guiding means can in particular be formed as at least one rod and thereto corresponding axial bearings, however other linear guiding means are possible as well. Typically, the at least one rod extends from the second mold half and the axial bearings are arranged in bores of the first mold half, however other arrangements are thinkable. In some variations the distance between first mold half and the second mold half in the open state is less than the length of the rods in the general direction of separation, allowing a continuous guiding of the mold halves relative to each other between the open and the closed state.

The injection molding device as described above can comprise an injection molding machine. The injection molding machine typically comprises two clamping plates arranged linearly movable relative to each other in the first direction for exerting pressure therebetween in a clamping position. At least one of the clamping plates can act as the first carrier.

Good performance is possible, when the second mold carrier comprises at least two side faces each having a second mold half attached thereto and the second mold carrier being arranged rotatable about a rotation axis extending perpendicular to the first direction during operation for rotating the cavity module from the first into the second position. The side face faces may carry similar or different second mold halves. The second mold carrier is preferably arranged between the two clamping plates of the injection molding machine. Either one or both of the clamping plates can act as a first mold carrier. In the proximal position the two clamping plates are interconnected to two side faces of the second mold carrier arranged in the first direction opposite of each other. This allows to press the first and the second mold half in the first position against each other in the first position, while essentially no forces in the first direction are applied to the rotatable second mold carrier in the proximal/clamping position.

Alternatively or in addition, a transfer device can be arranged for sliding at least one of the cavity modules in a lateral direction essentially perpendicular to the first direction from the first into the second position. The cavity module is typically disconnected from the first and the second mold carrier, when slid from the first position into the second position. The transport device can be formed as a conveyor, in some cases as a continuous conveyor. If appropriate the transport device comprises per cavity module a support comprising sliding bearings for supporting the cavity module during transport, however other implementations are possible as well, such as a roller conveyor. The first and the second mold carrier are preferably incorporated into the clamping plates of the injection molding machine.

In some variations the first mold carrier and/or the second mold carrier comprise actuating means coupled in the proximal position with the latching means of the cavity module in the first position, for locking and/or unlocking of the latching means. Depending on the design, the actuating means can be arranged at or in the second mold carrier.

Preferably the first and/or the second mold carrier are at least temporarily interconnected to the first and/or the second mold half by quick coupling means for establishing at least temporarily an electrical and/or hydraulic and/or pneumatic and/or coolant connection therebetween. This allows e.g. to connect temperature or pressure sensors arranged in the first and/or the second mold to be interconnected to the first and/or the second mold carrier and therefrom to e.g. to the controller.

To provide efficient cooling of the at least one cavity of the respective cavity module a cooling channel arranged in the first mold half is temporarily interconnected to a cooling circuit of the second mold carrier for exchange of cooling fluid. The cooling channel is preferably interconnected to the cooling circuit via quick coupling means.

A method for operating an injection molding device according to the disclosure, the method comprising the following step.

Providing an injection molding device usually comprising a first mold carrier and a second mold carrier arranged linearly movable relative to each other in a first direction between a proximal position and a distal position. The injection molding device further comprises at least two cavity modules cycling during operation between a first position and at least one second position. The first position being essentially between the first and the second mold carrier and the at least one second position usually being lateral to the first and the second mold carrier. Each of the at least two cavity modules comprising a first mold half and a thereto corresponding second mold half, in a closed state forming at least one cavity therebetween. The at least one cavity being suitable to receive melted plastic material via at least one cavity gate arranged in the first mold half to form at least one plastic part from the melted plastic material by curing; the cavity module usually comprising latching means to lock the first mold half with respect to the second mold half in the closed state during transfer of the cavity module from the first position, between the first and the second mold carrier, into the second position, lateral to the first and the second mold carrier. A melted plastic pass through means typically attached to the first mold carrier and being in the first position of the cavity module. During each molding cycle in the proximal position of the first and the second mold carrier, the melted plastic pass through means is interconnected to the first mold half of one of the at least two cavity modules for supplying melted plastic material into the cavity via the cavity gate.

The method comprising the following steps of moving a cavity module from the at least one second position, lateral to the first and the second mold carrier, into the first position, between the first and the second mold carrier; moving the first mold carrier and the second mold carrier relative to each other in a first direction from the distal position into the proximal position, thereby interconnecting the melted plastic pass through means attached to the first mold carrier to the first mold half of the cavity module; supplying by the melted plastic pass through means melted plastic material to the cavity via the cavity gate arranged in the first mold half to form at least one plastic part from the melted plastic material; moving the first mold carrier and the second mold carrier from the proximal position into the distal position thereby disconnecting the melted plastic pass through means from the first mold half; and moving the cavity module in the closed state from the first position into the at least one second position.

In order to produce high quality plastic parts, the melted plastic material is supplied to the cavity by the injection nozzle and the needle being moved: from the intermediate position into the retracted position to open the nozzle gate; from the retracted position into the extended position, in which the needle closes the nozzle gate and extends into the cavity gate of the first mold half; and from the extended position into the intermediate position to prevent damage to the needle when disconnecting the first mold half and the melted plastic pass through means.

Depending on the field of application, the second mold carrier comprises at least two side faces having a second mold half attached thereon. Here the second mold carrier is rotated about a rotation axis extending perpendicular to the first direction during operation for moving the cavity module in the closed state from the first into the second position, the second mold carrier rotates in particular 90 degree or 180 degrees about the rotation axis or pivots about 90 degrees.

In a preferred variation the method comprises displacing the first and the second mold halves of one of the cavity modules relative to each other from the closed state into an open state, such that the molded plastic parts can be removed and/or ejected. If appropriate the mold halves interconnected to the respective first and second mold carriers, are moved into the open state in the first position by moving the first and second mold carriers from the proximal position into the distal position. Alternatively, the mold halves are moved into the open state in the at least one second position by a demolding device temporarily interconnected to the first mold half and/or the second mold half.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings are showing:

FIG. 1 a schematic top down view of a first variation of an injection molding device according the disclosure;

FIG. 2 a schematic top down view of the first variation of FIG. 1 in another position;

FIG. 3 a schematic top down view of the first variation of FIG. 1 in another position;

FIG. 4 a schematic top down view of the first variation of FIG. 1 in another position;

FIG. 5 a schematic top down view of the first variation of FIG. 1 in another position;

FIG. 6 a schematic top down view of the first variation of FIG. 1 in another position;

FIG. 7 a schematic top down view of the first variation of FIG. 1 in another position;

FIG. 7′ a schematic top down view of the first variation of FIG. 1 in another position;

FIG. 8a a schematic top down view of the first variation of FIG. 1 in another position;

FIG. 8b a schematic top down view of the first variation of FIG. 1 in another position;

FIG. 9 a schematic top down view of the first variation of FIG. 1 in another position;

FIG. 10 a schematic top down view of a second variation of an injection molding device according the disclosure;

FIG. 11 a schematic top down view of the second variation of FIG. 10 in another position;

FIG. 12 a schematic top down view of the second variation of FIG. 10 in another position;

FIG. 13 a schematic top down view of the second variation of FIG. 10 in another position;

FIG. 14 a schematic top down view of the second variation of FIG. 10 in another position;

FIG. 15 a schematic top down view of the second variation of FIG. 10 in another position;

FIG. 16 a schematic top down view of the second variation of FIG. 10 in another position;

FIG. 17 a schematic top down view of the second variation of FIG. 10 in another position;

FIG. 18 a sectional view of the first variation of the injection molding device of FIG. 2, indicated by section line A; and

FIG. 19 a perspective view of the first variation in the position of FIG. 8b.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

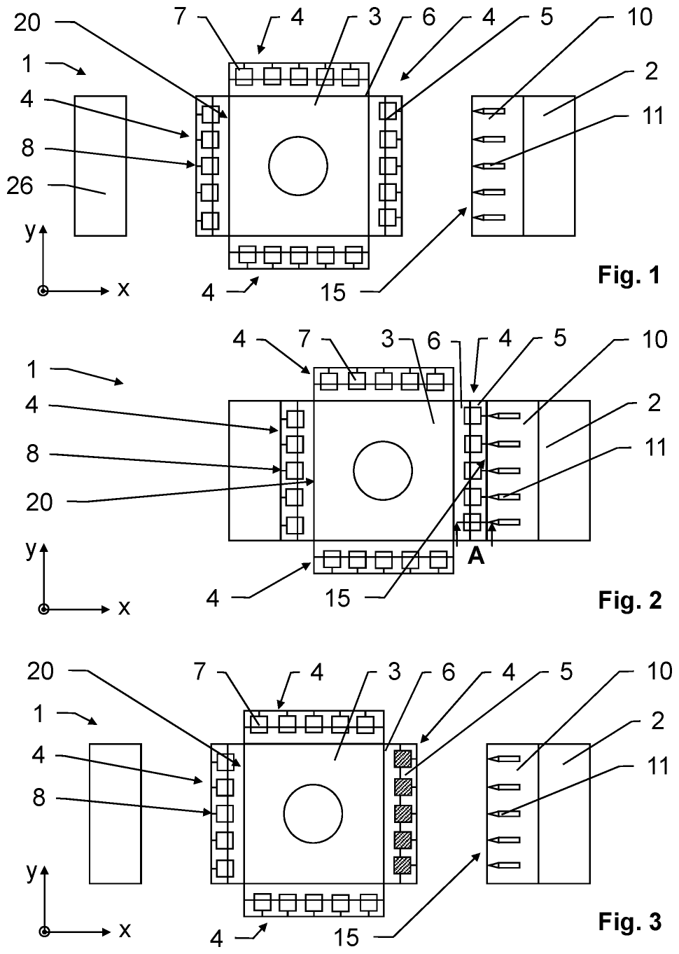

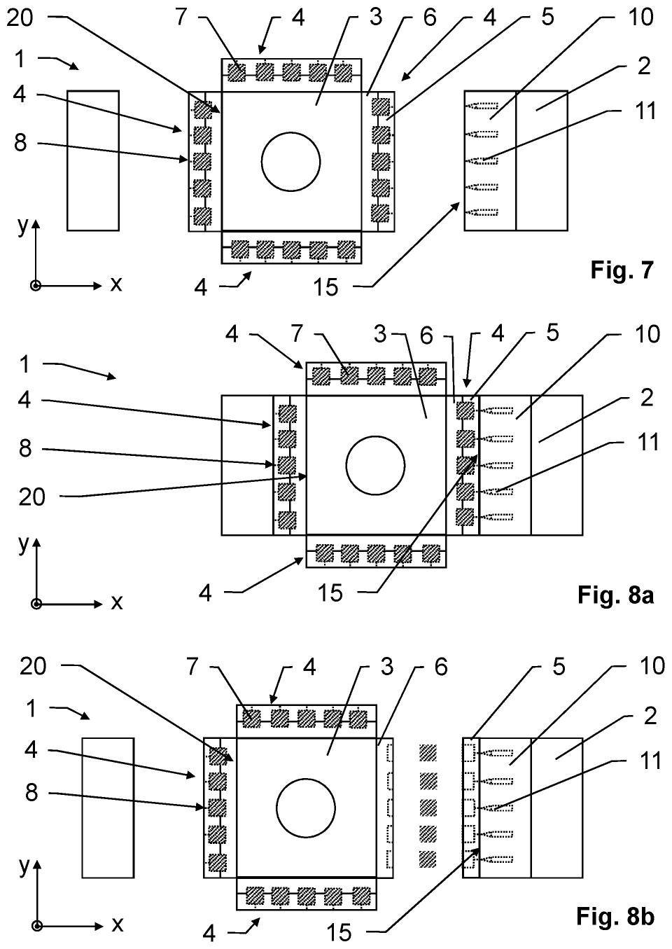

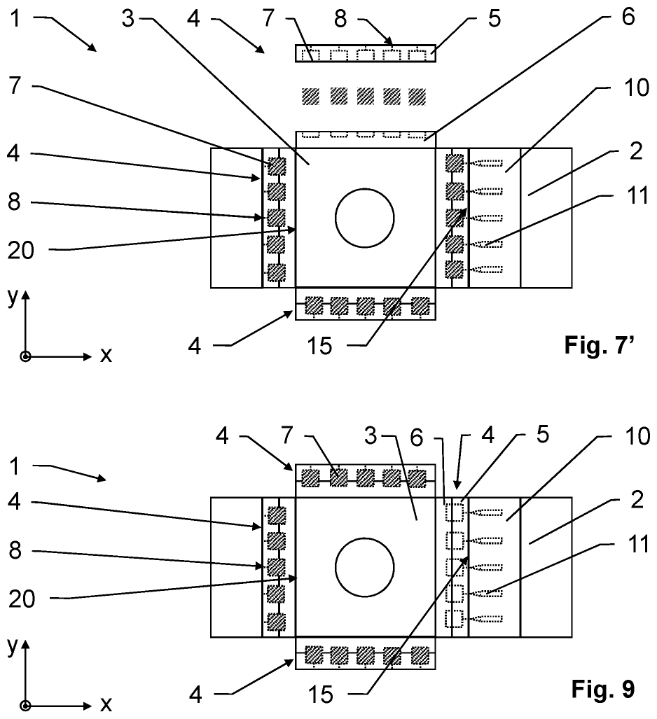

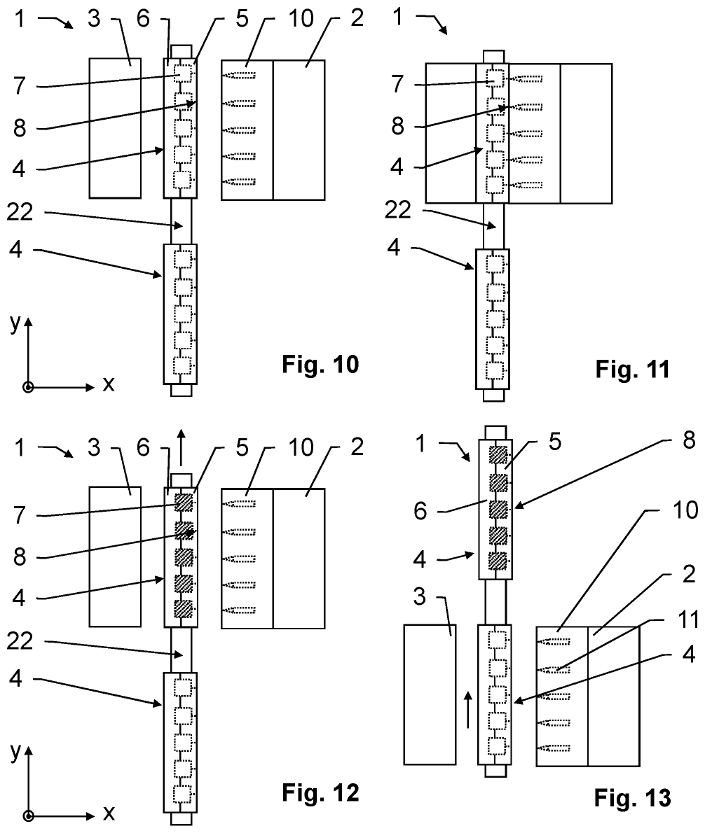

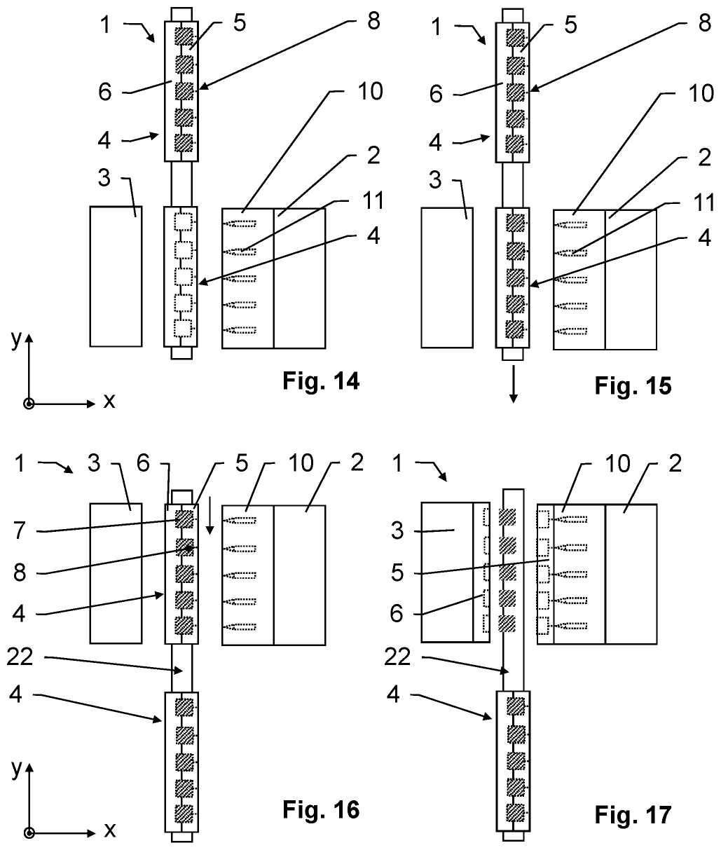

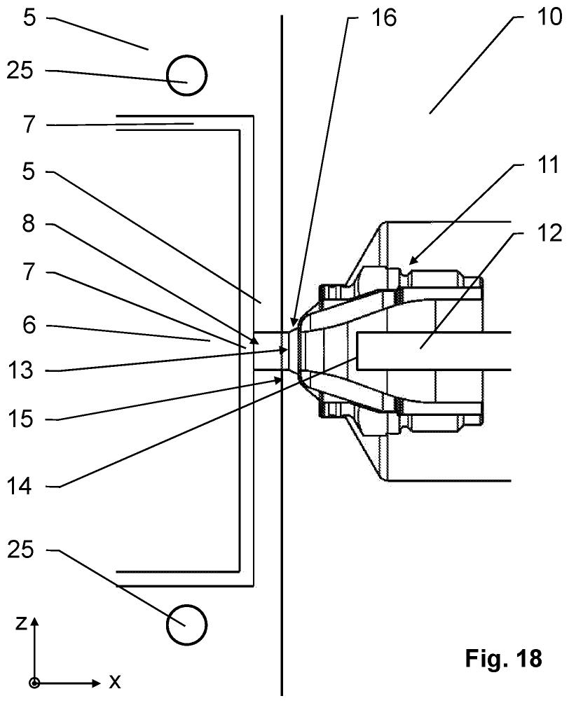

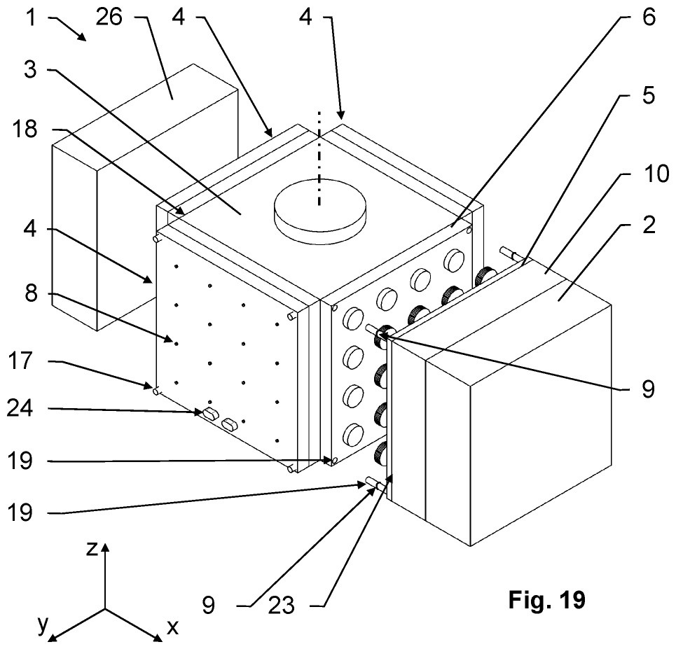

FIGS. 1 to 9 show a first variation of an injection molding device 1 in an exemplary cycle. The positions shown in FIGS. 8a and 8b are usually an alternative to the position shown in FIG. 7′. FIGS. 10 to 17 show a second variation of an injection molding device 1 in an exemplary cycle. FIG. 18 shows a sectional view of the first variation of the injection molding device 1 in the position of FIG. 2, indicated by section line A. FIG. 19 is showing a perspective view of the first variation in the position of FIG. 8b.

An injection molding device 1 as shown in FIGS. 1 to 19 usually comprises a first mold carrier 2 and a second mold carrier 3 arranged linearly movable relative to each other in a first direction x between a proximal position and a distal position. Typically, the first mold carrier 2 is stationary during operation. The injection molding device 1 further comprises at least two cavity modules 4 cycling during operation between a first position and at least one second position. The first position being essentially between the first and the second mold carrier 2, 3 and the at least one second position usually being lateral to the first and the second mold carrier 2, 3. The first variation comprises four cavity modules 4, whereas the second variation comprises two cavity modules 4.

Each cavity modules 4 comprises a first mold half 5 and a thereto corresponding second mold half 6, in a closed state forming at least one cavity 7 therebetween. The closed state is for example shown in FIG. 8a and an open state of a cavity module 4 is shown in FIG. 8b. The at least one cavity 7 being suitable to receive melted plastic material via at least one cavity gate 8 arranged in the first mold half 5 to form at least one plastic part from the melted plastic material by curing.

In the open state the plastic part can be removed after curing. The mold halves 5, 6 can be moved into the open state while being interconnected to the respective first and second mold carriers 2, 3 in the first position, by moving the first and second mold carriers 2, 3 from the proximal position into the distal position. This is shown in FIGS. 8a and 8b. Alternatively, this can be done in a second position by a demolding device (not shown), this is shown in FIG. 7′.

The cavity modules 4 usually comprise latching means 9 to lock the first mold half 5 with respect to the second mold half 6 in the closed state during transfer of the cavity module 4 from the first position, between the first and the second mold carrier 2, 3, into the second position, usually lateral to the first and the second mold carrier 2, 3.

A melted plastic pass through means 10 typically attached to the first mold carrier 2 is interconnected to the first mold half 5 of the cavity module 4 is in the first position of the cavity module 4 and in the proximal position of the first and the second mold carrier 2, 3 during each molding cycle for supplying melted plastic material into the cavity 7 via the at least one cavity gate 8. The melted plastic pass through means 10 comprises in the shown variation a hot runner system comprising at least one inlet, a hot runner manifold and typically a plurality of nozzles. The hot runner system usually comprises at least one temperature sensor and at least one heating element to maintain during operation an essentially uniform temperature of the melted plastic material passing through and into the at least one cavity.

A typical cycle comprises moving a cavity module 4 from the at least one second position, lateral to the first and the second mold carrier, into the first position, between the first and the second mold carrier 2, 3. FIGS. 1 and 10 show the first and the second mold carrier 2, 3 in the distal position and a cavity module 4 in the first position between the first and the second mold carrier 2, 3. In a typical cycle the first mold carrier and the second mold carrier 2, 3 are moved relative to each other in a first direction x from the distal position into the proximal position, thereby interconnecting the melted plastic pass through means 10 attached to the first mold carrier 2 to the first mold half 5 of the cavity module 4. This is shown in FIGS. 2 and 11.

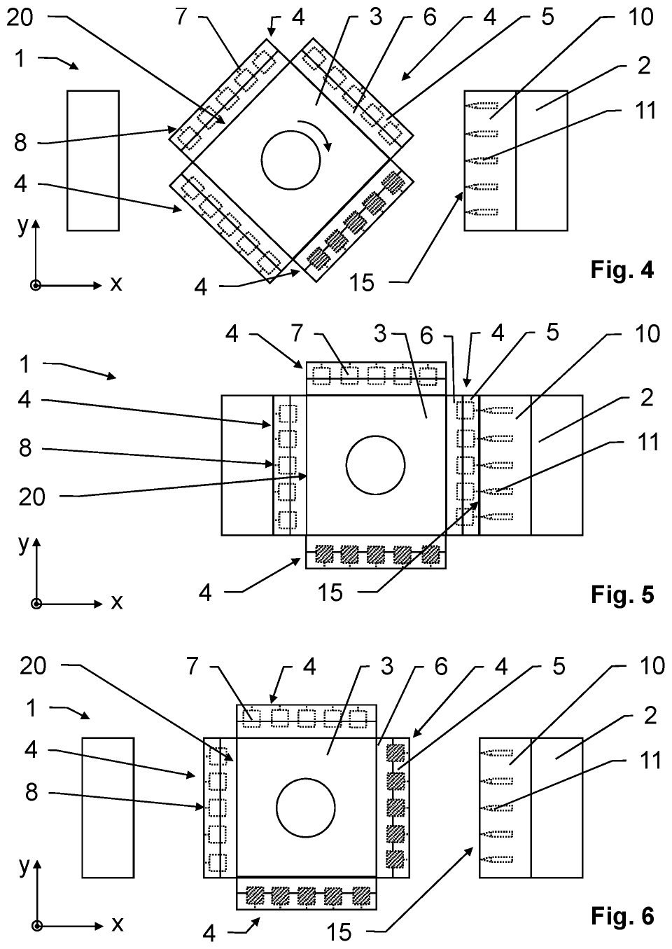

Usually melted plastic material is supplied by the melted plastic pass through means 10 to the at least one cavity 7 via the at least one cavity gate 8 arranged in the first mold half 5 to form at least one plastic part from the melted plastic material. Afterwards typically the first mold carrier 2 and the second mold carrier 3 are moved from the proximal position into the distal position thereby disconnecting the melted plastic pass through means 10 from the first mold half 5, as shown in FIGS. 3 and 12. Subsequently the cavity module 4 is moved in the closed state from the first position into the at least one second position, as shown in FIGS. 4 and 13. Typically, at the same time another cavity module 4 is moved from a second position into the first position.

In the first variation, as shown in FIGS. 1 to 9 and 19, the second mold carrier 3 comprises at least two side faces 20 each having a second mold half 6 attached thereto and the second mold carrier 3 being arranged rotatable about a rotation axis z extending perpendicular to the first direction x during operation for rotating the cavity module 4 from the first into the second position. In the shown variation, the second mold carrier 3 comprises four side faces 20 each having a second mold half 6 attached thereto and the second mold carrier 3 is rotated about 90 degrees.

In the second variation of the injection molding device 1, as shown in FIGS. 10 to 17, a transfer device 22 is arranged for sliding at least one of the cavity modules 4 in a lateral direction y essentially perpendicular to the first direction x from the first into the second position. Here the cavity module is disconnected from the first and the second mold carrier 2, 3, when slid from the first position into the second position. The transfer device 22 comprises in the shown variation a support comprising sliding bearings for supporting the cavity module during transport.

FIG. 18 shows a sectional view of the first variation in the position of FIG. 2, indicated in FIG. 2 by section line A. Here the melted plastic pass through means 10 comprises per cavity 7 at least one injection nozzle 11 being in the proximal position fluidly interconnected to the respective cavity 7 via the at least one cavity gate 8 for injecting melted plastic material into the respective cavity 7. The injection nozzle 11 comprises in this variation a needle 12 arranged movable between a retracted position and an extended position, to open a nozzle gate 13 in the retracted position and to close the nozzle gate 13 in the extended position. The nozzle gate 13 being arranged in a front face 15 of the melted plastic pass through means 10. FIG. 18 shows the needle 12 in the retracted position allowing melted plastic material to flow via the nozzle gate 13 and the cavity gate 8 into the cavity 7.

In a typical cycle, the needle 12 is being moved from the intermediate position into the retracted position to open the nozzle gate 13. To stop the injection, the needle 12 is moved from the retracted position into the extended position, in which the needle 12 closes the nozzle gate 13 and extends into the cavity gate 8 of the first mold half 5. To prevent damage to the needle 12 when disconnecting the first mold half 5 and the melted plastic pass through means 10, the needle 12 is moved from the extended position into the intermediate position.

As can be seen in FIG. 18, a lead in 16 is arranged at the nozzle gate 13 for leading the needle 12 when moved into the extended position. Here the lead in 16 is formed as a conical surface leading into the essentially cylindrical nozzle gate 13. The needle 12 comprises in the shown variation an end face 14 forming in the extended position temporarily part of the respective cavity 7. Good cooling of the at least one cavity 7, and the plastic material therein, is possible when a cooling channel 25 is arranged in the first mold half 5. The cooling channel 25 is temporarily interconnectable to a cooling circuit (not shown) of the second mold carrier for exchange of cooling fluid.

In FIG. 19 a perspective view of the first variation in the position of FIG. 8b is shown. The first mold half 5 is in the first position temporarily interconnected to the first mold carrier 2 by first holding means 17. Similarly, the second mold half 6 can be at least temporarily interconnected to the second mold carrier 3 by second holding means 18. In the first direction x opposite of the first mold carrier 2 a clamping plate 26 is arranged, in the proximal position acting as a mechanical support for exerting pressure between the mold halves 5, 6 in the first position.

In order to guide the first and the second mold half 5, 6 when moved between the closed and the open state the respective cavity module 4 comprises linear guiding means 19. In the shown variation the linear guiding means 19 are formed as rods attached to the first mold half 5 and axial bearings arranged in the second mold half 6.

In the shown variation, the latching means 9 are formed as a groove arranged at the linear guiding means 19. In addition, the first variation comprises alignment means 23 having at least one outer conical surface (not shown) and at least one inner conical surface (not shown) engaging when the first mold half 5 is interconnected to the first mold carrier 2 and/or the melted plastic pass through means 10 to align in particular the cavity gate 8 and the nozzle gate 13 concentrically. As can be further seen in FIG. 19, the first mold half 5 comprises quick coupling means 24, in particular for establishing an electrical connection with the first mold carrier 2 and/or the melted plastic pass through means 10.

Rather, the words used in the specification are words of description rather than limitation, and it is understood that various changes may be made without departing from the scope of the disclosure.

What is claimed is:

1. Injection molding device suitable for injection molding and curing of plastic parts, the injection molding device comprising:
a. a first mold carrier and a second mold carrier arranged linearly movable relative to each other in a first direction between a proximal position and a distal position;
b. at least two cavity modules cycling between a first position between the first and the second mold carrier and at least one second position lateral to the first and the second mold carrier;
C. the at least two cavity modules each comprising
i. a first mold half and a thereto corresponding second mold half in a closed state forming at least one cavity therebetween, the at least one cavity being suitable to receive melted plastic material via at least one cavity gate arranged in the first mold half to form at least one plastic part from the melted plastic material by curing;
ii. latching means to lock the first mold half with respect to the second mold half in the closed state during transfer of the cavity module from the first position, between the first and the second mold carrier, into the second position, lateral to the first and the second mold carrier; and
d. a melted plastic pass through means attached to the first mold carrier and being in the first position of the cavity module, during each molding cycle in the proximal position of the first and the second mold carrier, interconnected to the first mold half of one of the at least two cavity modules for supplying melted plastic material into the cavity via the at least one cavity gate.

2. The injection molding device according to claim 1, wherein the melted plastic pass through means comprises per cavity at least one injection nozzle being in the proximal position fluidly interconnected to the respective cavity via the cavity gate for injecting melted plastic material into the respective cavity.

3. The injection molding device according to claim 2, wherein the at least one injection nozzle comprises a needle arranged movable between a retracted position and an extended position, to open a nozzle gate in the retracted position and to close the nozzle gate in the extended position.

4. The injection molding device according to claim 3, wherein the needle comprises an end face in the extended position temporarily forming part of the respective cavity.

5. The injection molding device according to claim 3, wherein the needle is arranged movable to an intermediate position between the retracted and the extended position, such that in the intermediate position the end face closes the nozzle gate arranged in a front face of the melted plastic pass through means in a sealing manner.

6. The injection molding device according to claim 3, wherein a lead in arranged at the nozzle gate for leading the needle when moved into the extended position, in particular for centering the needle coaxially to the cavity gate.

7. The injection molding device according to claim 1, wherein in the first position the first mold half is temporarily interconnected to the first mold carrier by first holding means.

8. The injection molding device according to claim 1, wherein in the first position the second mold half is temporarily interconnected to the second mold carrier by second holding means.

9. The injection molding device according to claim 1, wherein the first mold half is arranged linear displaceable with respect to the second mold half between an open state and the closed state by linear guiding means incorporated in the corresponding cavity module.

10. The injection molding device according to claim 1, wherein the second mold carrier comprises at least two side faces each having a second mold half attached thereto, the second mold carrier being arranged rotatable about a rotation axis extending perpendicular to the first direction during operation for rotating the cavity module from the first into the second position.

11. The injection molding device according to claim 1, wherein first mold carrier and/or the second mold carrier comprise actuating means coupled in the proximal position with the latching means of the cavity module in the first position, for locking and/or unlocking of the latching means.

12. The injection molding device according to claim 1, wherein a transfer device is arranged for sliding at least one of the cavity modules in a lateral direction essentially perpendicular to the first direction from the first into the second position.

13. The injection molding device according to claim 1, wherein the first mold half is in the proximal position aligned with the melted plastic pass through means in a direction perpendicular to the first direction by alignment means.

14. The injection molding device according to claim 1, wherein the first and/or the second mold carrier are at least temporarily interconnected to the first and/or the second mold half by quick coupling means for establishing at least temporarily an electrical and/or hydraulic and/or pneumatic and/or coolant connection therebetween.

15. The injection molding device according to claim 1, wherein a cooling channel arranged in the first mold half is temporarily interconnected to a cooling circuit of the second mold carrier for exchange of cooling fluid.
